(19) United States
(12) Patent Application Publication
(10) Pub. No.: US 2025/0244752 A1
(43) Pub. Date: Jul. 31, 2025

(54) Integrated Artificial Intelligence Based Material Selection for Industrial Assets

(71) Applicant: Saudi Arabian Oil Company, Dhahran (SA)

(72) Inventors: James Arukhe, Dhahran (SA); Olanrewaju Olawuyi, Dhahran (SA)

(21) Appl. No.: 18/426,729

(22) Filed: Jan. 30, 2024

(51) Int. Cl. G05B 19/418

(52) U.S. Cl. CPC G05B 19/41865; G05B 2219/33038

(57) ABSTRACT

A computer-implemented method that enables the selection of materials for industrial assets is described. The method includes obtaining historical data from a database. Industry standards are integrated with this historical data, and the data is filtered to create multiple training datasets that comply with these standards. The method further involves training one or more machine learning models using these datasets. A recommendation for material selection is generated based on the predictions from the trained models, using a validation mechanism to ensure compliance with industry standards.

### TECHNICAL FIELD

This disclosure relates generally to the selection of materials for industrial assets using integrated machine learning models.

### BACKGROUND

Industrial assets include machines, tools, and equipment used to produce goods or materials. Industry standards ensure that materials used in the construction of industrial assets meet the rigorous demands of their respective operational environment.

### BRIEF DESCRIPTION OF DRAWINGS

FIG. 1 shows a workflow that enables the selection of materials for industrial assets using integrated machine learning models.

FIG. 2 shows a system that enables the selection of materials for industrial assets using integrated machine learning models.

FIG. 3 shows an implementation of algorithms that enable the selection of materials for industrial assets using integrated machine learning models.

FIG. 4 is a process flow diagram of a process that enables the selection of materials for industrial assets responsive to user inputs using integrated machine learning models.

FIG. 5 shows capabilities of integrated machine learning models.

FIG. 6 is a process flow diagram that enables the selection of materials for industrial assets using integrated machine learning models.

FIG. 7 illustrates hydrocarbon production operations that include both one or more field operations and one or more computational operations, which exchange information and control exploration for the production of hydrocarbons.

FIG. 8 is a schematic illustration of an example controller (or control system) that enables the selection of materials for industrial assets using integrated machine learning models.

### DETAILED DESCRIPTION

Selection of materials for industrial assets using integrated machine learning models is described. Industrial assets include machines, tools, and equipment used to produce goods. In the oil and gas industry, for example, industrial assets include structures, pipelines, and equipment used to produce oil and gas. Standards from organizations like the American Petroleum Institute (API) or the National Association of Corrosion Engineers (NACE) provide specific guidelines on material selection based on various factors, ensuring safety, reliability, and durability.

Embodiments described herein include predicting the long term performance (e.g., material degradation such as metal loss, corrosion, failure, pitting, and the like) of materials using artificial intelligence (AI). The predictions are used to guide recommendations on material selection for industrial assets. Historical data is obtained from a database. Historical data includes, for example, operational data (e.g., temperature, pressure, offshore, onshore and chemical data) and material properties associated with structures, pipelines, or equipment. Industry standards are integrated with the historical data, where the historical data is filtered to obtain multiple training datasets that comply with industry standards. One or more machine learning models are trained to predict material performance using the multiple training datasets, where predictions from the trained multiple machine learning models are cross-referenced to predict material performance in response to input operating conditions. The construction or selection of materials used in industrial assets is based on the predicted material performance and adheres to industry standards.

Some advantages of the present techniques include an improvement to material selection through an integrated and robust ensemble of artificial intelligence based models. By integrating industry standards and a rigorous selection criterion into the AI-driven solution, an extended asset lifespan is realized due to the use of materials best suited for the respective environment. Additionally, maintenance costs are reduced stemming from fewer material failures, and operational efficiency is enhanced by ensuring that the most corrosion-resistant materials are chosen for each specific application.

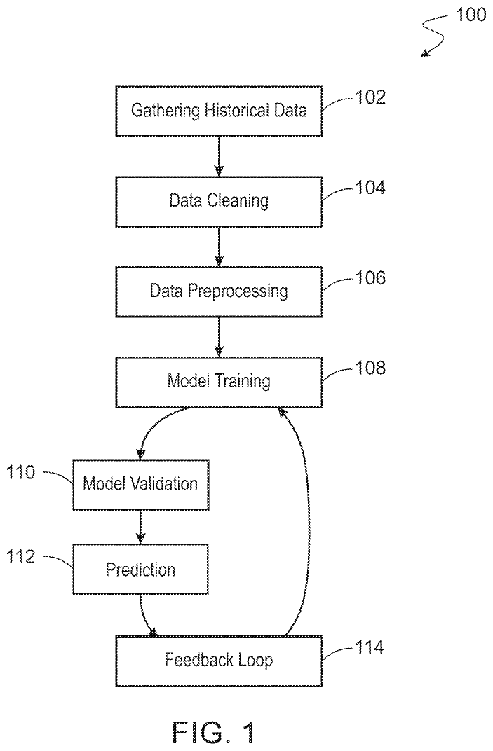

FIG. 1 shows a workflow 100 that enables the selection of materials for industrial assets using integrated machine learning models. At block 102, historical data is gathered. In examples, the historical data is related to material performance. For example, historical data can include operating conditions such as temperature, pressure, chemical environment, and corrosion rates associated with an industrial operation. Historical data can also include material properties or performance metrics such as levels of wear and tear, material lifespan, and other relevant metrics. The material properties and performance metrics of various materials are captured in different environments or operating conditions. Historical data includes both intrinsic properties of materials and real-world performance metrics. Accordingly, historical data includes operating conditions, material properties, and their performance outcomes.

In some embodiments, the historical data is filtered to remove data points in the historical data do not adhere to industry standards. Historical data that adheres to industry standards is used to train the machine learning models, thereby integrating the industry standards with the machine learning models. This integration ensures the reliability and relevance of materials selected for industrial assets using the machine learning models. In some embodiments, guidelines are recognized industry standards, such as those set by the American Petroleum Institute (API) or the National Association of Corrosion Engineers (NACE). These standards provide a benchmark for material performance and safety. In some embodiments, industry standards are industry norms that evolve over time.

In some embodiments, automated data ingestion pipelines are in place to scan and incorporate updates from authoritative industry sources. The updates from authoritative industry sources are structured to be compatible with the automated data ingestion pipelines. These updates often come in standardized formats such as XML, JSON, or CSV files, which are widely used in data exchange and can be easily processed by the system. In cases where the updates are not in a directly ingestible format, they undergo a preprocessing step where the data is converted into a format suitable for integration into the system's database.

At block 104, data cleaning is performed. Data cleaning is the process of removing any inconsistencies or errors from the collected data.

At block 106, data preprocessing is performed. In data preprocessing, the cleaned data is transformed into a format suitable for model training.

At block 108, model training begins. During training, established selection criteria is considered, ensuring that the machine learning model's predictions are both optimal and compliant with industry norms. Initially, the cleaned and preprocessed data generated at blocks 104 and 106 are used to train supervised learning models, such as Support Vector Machines or Decision Trees. These machine learning models learn the patterns and relationships between operating conditions, material properties, and their performance outcomes. In some embodiments, operating conditions are associated with material properties and/or performance outcomes as ground truth labels. In some embodiments, the operating conditions are associated with material properties and/or performance outcomes based on the established selection criteria (e.g., universally accepted, unofficial industry standards and best practices).

In examples, established selection criteria refer to predefined standards or guidelines that are used to evaluate and select materials for specific applications, particularly in industrial settings. These criteria are based on industry norms, regulatory statutes, and best practices. They encompass ranges, values, or guidelines associated with various factors such as material properties (like strength, durability, corrosion resistance), environmental conditions (like temperature, pressure, chemical exposure), and operational requirements (like safety, efficiency, cost-effectiveness).

In the context of the AI-driven material selection system for industrial assets, established selection criteria are considered during the model training process. Accordingly, the machine learning models are trained on historical data, real-world performance metrics, and also on data that aligns with these established criteria. By integrating these criteria, the AI models are trained to recognize and prioritize patterns and relationships that are not only data-driven but also compliant with industry standards and best practices. This integration ensures that the Al's recommendations for material selection are not just based on historical data trends but are also aligned with industry norms, safety standards, and operational efficiency requirements. It adds a layer of reliability and relevance to the AI predictions, making them more applicable and trustworthy for real-world industrial applications.

In the context of training supervised learning models like Support Vector Machines or Decision Trees, the historical data is labeled to provide a clear indication of the outcomes or classifications that the model is supposed to learn. This labeling process involves assigning specific labels or tags to each data point, indicating the desired output or category based on the input features (such as operating conditions and material properties).

The labeling of historical data can be done in several ways. For example, ground truth labels involve labeling the data based on actual observed outcomes or performance metrics. For instance, if the historical data includes information about how different materials performed under certain operating conditions, these performance outcomes (like corrosion rate, failure, wear and tear rate) are used as labels. This approach ensures that the model learns from real-world outcomes.

In examples, the data is labeled based on established industry standards and selection criteria. This means that the data is labeled not just based on observed outcomes but also considering whether the materials and their performance align with industry norms, safety standards, and best practices. For example, a material that performs well under high temperatures and pressures and meets API or NACE standards would be labeled positively in this context.

In examples, a combination of both ground truth outcomes and compliance with industry standards is used for labeling. This hybrid approach ensures that the model learns from actual performance data while also aligning its predictions with industry-relevant criteria.

The machine learning models are trained to predict material performance based on input variables (e.g., operating conditions) like temperature, pressure, and chemical environment. In examples, material performance refers to a rate of material degradation, such as a rate or measure of metal loss, corrosion, failure, pitting, and the like. At block 110, the trained machine learning models are validated. In model validation, the trained machine learning model's accuracy and reliability is compared against a validation dataset. In some embodiments, the material predictions are benchmarked against traditional or heuristic-based methods to assess accuracy and reliability.

At block 112, predictions are made by the one or more trained, validated machine learning models. The trained machine learning models predict the performance of various materials under unobserved operating conditions. For example, the trained machine learning models predict the long-term performance of materials under specific conditions, including performance metrics like corrosion rate and optimal operating ranges, and material properties such as material lifespan. In examples, optimal operating ranges for pipelines may be a temperature between 20-50° C. and pressure from 70-145 psi. The trained machine learning models take unseen input variables (operating conditions) and predict the material properties or performance outcomes of various materials under those conditions.

The quantity of machine learning models used to predict material performance depends on the complexity and diversity of the data, as well as the specific requirements of the prediction task. Both approaches have their advantages and considerations. For example, using multiple trained machine learning models to predict the performance of various materials under unobserved operating conditions enables specialization and robustness. Specialization refers to using different models to specialize in predicting different aspects of material performance, such as corrosion rate, tensile strength, or fatigue life. This can be particularly useful when dealing with a wide range of materials and operating conditions. Robustness refers to mitigating the weaknesses of one trained machine learning model by relying on other trained machine learning models to avoid weaknesses. In some embodiments, each trained machine learning model is trained using a respective data type.

In examples, using a single trained machine learning model to predict the performance of various materials under unobserved operating conditions can be developed, maintained, and deployed on systems with limited computational resources. Additionally, predictions from a single trained machine learning model can be consistent, as they are based on a unified set of learned patterns.

In the example of FIG. 1, that multiple machine learning models are trained and validated (as shown in blocks 108 and 110) to predict the performance of various materials under unobserved operating conditions. In examples, using multiple trained machine learning models leverages the strengths of different models to achieve a comprehensive and accurate prediction of material performance. This can be particularly effective in industrial applications where the range of materials and operating conditions is broad and varied.

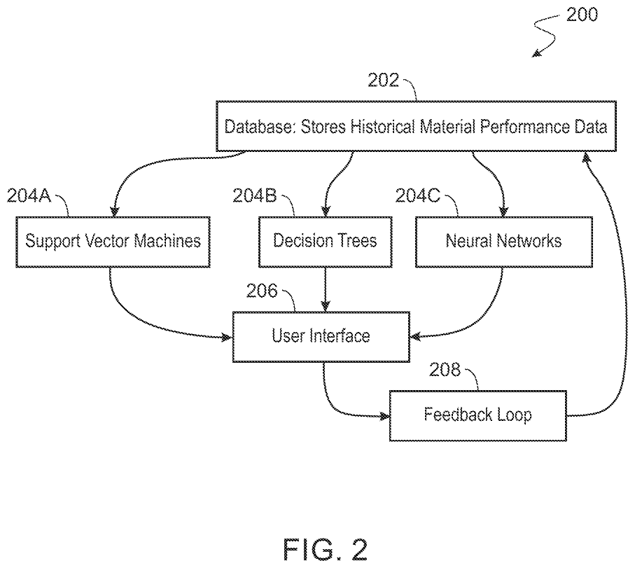

Based on the predicted material properties or performance outcomes, a recommendation on materials suited for the particular operating conditions is generated. The predictions output by the trained machine learning models are based on raw, unseen input data and are also in adherence with the industry standards and selection criteria. This ensures that the material recommendations are both optimal and compliant. The recommendations prioritize materials that are corrosion-resistant, durable, and meet the required industry standards. For example, an AI system (e.g., system 200 of FIG. 2) recommends the most corrosion-resistant materials for specific applications based on AI-driven predictions. The recommendations also consider other established selection criteria, ensuring a holistic approach to material selection.

In some embodiments, safety and quality checks are performed to generate a final material recommendation. For example, a validation mechanism is applied to the material recommendation that cross-references the Al's prediction with established code, safety and quality standards. Before finalizing any recommendation, the system references a database of industry standards to ensure that the suggested materials or conditions align with accepted norms. Additionally, post-prediction filters are applied to ensure that any recommendation made falls within the acceptable ranges or criteria set by industry guidelines. In some embodiments, human oversight is applied to the material recommendation so that human experts can manually review and validate the Al's prediction, ensuring that the material recommendations align with real-world requirements and safety standards.

In scenarios where the system's predictions might conflict with industry standards, a multi-tiered approach is adopted. First, any conflicting prediction is flagged for review. The system then provides a detailed analysis of the factors leading to the prediction, allowing for a deeper understanding of the potential discrepancy. In some cases, domain experts are consulted to provide insights and resolve the conflict. If the conflict remains unresolved, the system defaults to the industry standard, ensuring that safety and compliance are not compromised. In examples, a conflict with industry standards is the failure of a material to satisfy ranges, values, or guidelines put forth by the standard.

At block 114, feedback is captured. Process flow returns to block 108 where the machine learning models are re-trained using the captured feedback. As additional data becomes available or industry standards evolve, the system can be retrained, ensuring that its recommendations remain current and in line with the latest best practices. The feedback loop at block 114 represents the iterative nature of machine learning, where models are continuously trained with additional data to improve accuracy. In some embodiments, the feedback data is cleaned and preprocessed prior to retraining the machine learning models.

FIG. 2 shows a system 200 that enables the selection of materials for industrial assets using integrated machine learning models. In examples, the system 200 is an AI-based system that implements the workflow 100 of FIG. 1. The system 200 is designed to be user-friendly, continuously updated, and seamlessly integrated into existing systems. In some embodiments, the system 200 integrates with procurement systems, CAD software, and other engineering tools through the development of APIs.

The system 200 includes a database 202, machine learning models 204, a user interface 206, and a feedback loop 208. In some embodiments, the system 200 is cloud based, the system 200 is hosted by a cloud service to ensure scalability, easy access, and real-time updates. Basing the system 200 in the cloud also enables remote access and ease of updates. The database 202 stores historical data and other training data (e.g., feedback data). In examples, the database 202 stores data that is gathered, cleaned, and preprocessed as described at blocks 102, 104, and 106 of FIG. 1. The system 200 employs a rigorous data validation process that cross-references collected historical data with recognized industry databases and repositories. This ensures that any material properties, corrosion rates, and other relevant data align with the values and ranges specified in current industry standards. In this manner, historical data is filtered to remove data points in the historical data do not adhere to industry standards. Additionally, the system uses automated data integrity checks to identify and flag any outliers or data points that deviate significantly from established norms.

Machine learning models 204A, 204B, and 204C are shown in FIG. 2 (collectively referred to as machine learning models 204). In the example of FIG. 2, the machine learning models 204 are support vector machines 204A, decision trees 204B, and neural networks 204C. However, any machine learning models may be used according to the present techniques. In some embodiments, different machine learning models are trained to process and predict material performance. Established industry standards are integrated into the machine learning models by creating training datasets that adhere to the specifications and guidelines set by recognized industry bodies. This ensures that the machine learning models learn from data that is both accurate and relevant. Additionally, during a feature engineering phase of machine learning, attributes derived from industry standards, such as acceptable ranges or thresholds for certain material properties, are used to create new features or modify existing ones. This helps the model to recognize and prioritize patterns that align with industry norms and expectations.

During the feature engineering phase, raw data is transformed and enriched to improve the model's performance. This process involves creating new features or modifying existing ones based on domain knowledge, which in this case includes industry standards and guidelines. Feature engineering aims to make the data more suitable for machine learning algorithms, enhancing their ability to learn patterns and make accurate predictions. In examples, features are created (e.g., new features) that encapsulate aspects of the industry standards, such as specific thresholds, ranges, or criteria that materials must meet. In examples, features are modified, adjusted, or reinterpreted in light of industry standards. For example, certain operational conditions might be categorized or scaled according to how they align with standard practices. In examples, the features are transformed. This could involve normalizing data, handling missing values, or converting categorical data into a format that can be processed by machine learning algorithms. Additionally, in examples techniques such as Principal Component Analysis (PCA) are used to reduce the number of features while retaining the most important information.

Selection criteria are integrated into the machine learning models by creating training datasets that give more weight to selection criteria that have a more significant impact on material performance and longevity. These criteria might include corrosion resistance, tensile strength, fatigue limits, thermal stability, electrical conductivity, weight, cost-effectiveness, and environmental impact among others. For instance, in aerospace applications, weight and thermal stability might be prioritized, while in electrical applications, conductivity and cost-effectiveness could be more crucial. The weighting is determined based on both industry standards and historical performance data. For instance, if a particular industry standard emphasizes the importance of a specific material property, the model will be trained to prioritize that property during its predictions. An example of an industry standard that emphasizes a critical selection criterion like corrosion resistance is NACE MR0175/ISO 15156. This standard provides guidelines for the selection of materials for sour service environments in the oil and gas industry, where hydrogen sulfide can cause severe corrosion. It specifies the types of materials that can resist sulfide stress cracking, thus emphasizing corrosion resistance as a key criterion in material selection.

In examples, the selection criteria are derived from universally accepted industry standards and best practices. Transparency in data sources and methodologies is ensured by periodic review of the selection criteria by independent third-party experts to eliminate potential biases. Additionally, the system is designed to be vendor-neutral, meaning it doesn't favor specific manufacturers or vendors of materials. Recommendations are based purely on material performance, compliance with standards, and the specific requirements of the given application.

For materials or conditions that lack well-established industry standards, historical data, expert input, and analogous materials or conditions with similar properties are used to make predictions. The materials or conditions that lack well-established industry standards are flagged for manual review, enabling the provision of expert insights or recommendations on the material or condition. Over time, as more data is collected for these less well-defined materials or conditions, the predictions for the respective materials or conditions are refined, and reliance on manual intervention is reduced.

A user interface 206 provides a platform where operating conditions are input. In some embodiments, the user interface 206 includes an input dashboard that enables input of operating conditions for a specific application. The user interface also includes an output visualization, where the predications and material recommendations are displayed in a human understandable format. For example, this can include predicted corrosion rates, material lifespan, and other performance metrics in a visual form, such as graphs or charts. Once trained, the machine learning models 204 predict the long-term performance of materials under specific conditions. Based on the predicted performance, the system recommends materials that are best suited for the given conditions. The predictions and recommended materials can be displayed via the user interface 206.

Feedback loop 208 represents the iterative nature of machine learning, where models are continuously trained with new data to improve accuracy. In some embodiments, the feedback data is cleaned and preprocessed prior to retraining the machine learning models. The feedback data includes, for example, real-world performance data. In this manner, the machine learning models continually refine their respective predictions based on new, unseen data. The machine learning models are also retrained as industry standards evolve, ensuring that its recommendations remain current and in line with the latest best practices.

In some embodiments, the feedback data includes providing insights and feedback on the system's recommendations from experts (e.g., humans) in the field. This feedback data ensures the system's accuracy and alignment with industry standards. Experts can highlight discrepancies, suggest improvements, and validate the system's outputs. This feedback is then used to refine the machine learning models and improve the overall accuracy and reliability of the system's recommendations.

In some embodiments, the machine learning models are retrained periodically, such as on a quarterly basis, to ensure alignment with the latest industry standards and selection criteria. These evaluations involve both automated checks and manual reviews by domain experts. Any discrepancies or areas of improvement identified during these evaluations are addressed promptly, ensuring that the system remains up-to-date and continues to provide reliable and compliant recommendations.

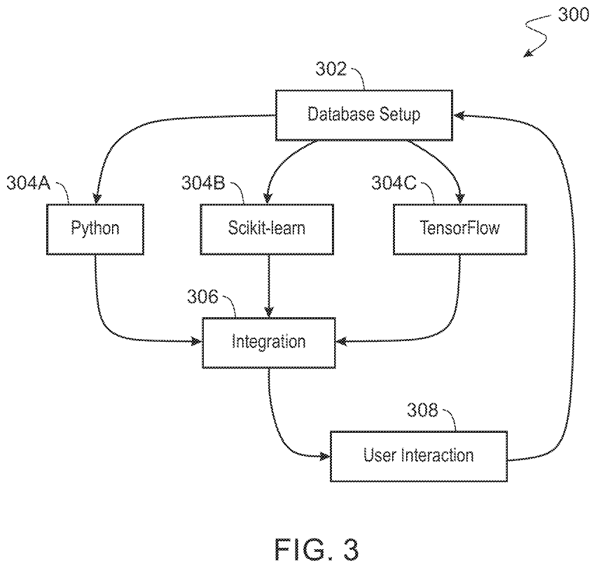

FIG. 3 shows an implementation 300 of algorithms that enable the selection of materials for industrial assets using integrated machine learning models. In examples, the implementation 300 executes using the system 200 of FIG. 3. In some embodiments, the implementation 300 integrates with procurement systems, CAD software, and other engineering tools through the development of APIs.

At block 302, database management is applied to at least one database. In examples, the at least one database is the database 202 of FIG. 2. A robust database system is established to store and manage vast amounts of historical data.

Programming languages and libraries are used to develop and implement algorithms that support the machine learning models, such as machine learning models 204 of FIG. 2. As shown in FIG. 3, machine learning models are coded and implemented using programming languages like Python at block 304A, utilizing libraries such as Scikit-learn at block 304B or TensorFlow at block 304C. Python serves as the foundation for implementing AI algorithms and handling data processing tasks. Scikit-learn offers a wide range of tools for data mining and data analysis. Scikit-learn is particularly useful for implementing traditional machine learning algorithms like Decision Trees and Support Vector Machines. TensorFlow is an open-source software library for high-performance numerical computation. TensorFlow is particularly adept at handling deep learning tasks, such as training complex neural network models. Using TensorFlow, the implementation 300 can utilize advanced neural networks for sophisticated material performance predictions. Although Python, Scikit-learn, TensorFlow are shown, the present techniques can be performed with different tools and libraries for algorithm implementation.

In examples, the database management at block 302, Python at block 304A, Scikit-learn at block 304B, and TensorFlow at block 304C are integrated as shown at block 306 to ensure seamless data flow and user experience. In examples, the integration is performed by a front end or management software. Further, a user interface is generated by the front end or management software. At block 308, user interactions with a user interface are represented. Users can input data and receive predictions. The input data and predictions generated in response to the user interactions are stored and managed by the database management at block 302. In this manner, new data can be added to the database based on user interactions.

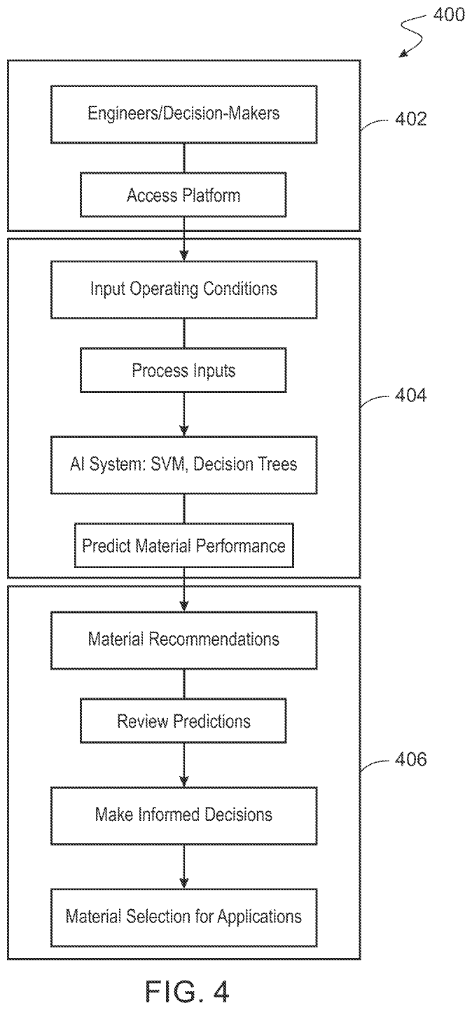

FIG. 4 is a process flow diagram of a process 400 that enables the selection of materials for industrial assets responsive to user inputs using integrated machine learning models.

At block 402, users (e.g., engineers/decision makers) access a user interface of the system to input operating conditions. In some embodiments, the platform is a dedicated platform for material selection. The users input the operating conditions associated with a specific application (e.g., temperature, pressure, loading, chemical environment, offshore, onshore, coastal).

At block 404, the input data is processed by the machine learning models. The machine learning models output predicted material properties or performance outcomes. The system provides material recommendations at block 406 on which materials would perform best under those conditions as in FIG. 4. This aids in making informed decisions about material selection for various applications. The predicted materials are reviewed and informed decisions are made. The materials are selected for use in various applications. Based on the predictions, users can make informed decisions about material selection for their applications.

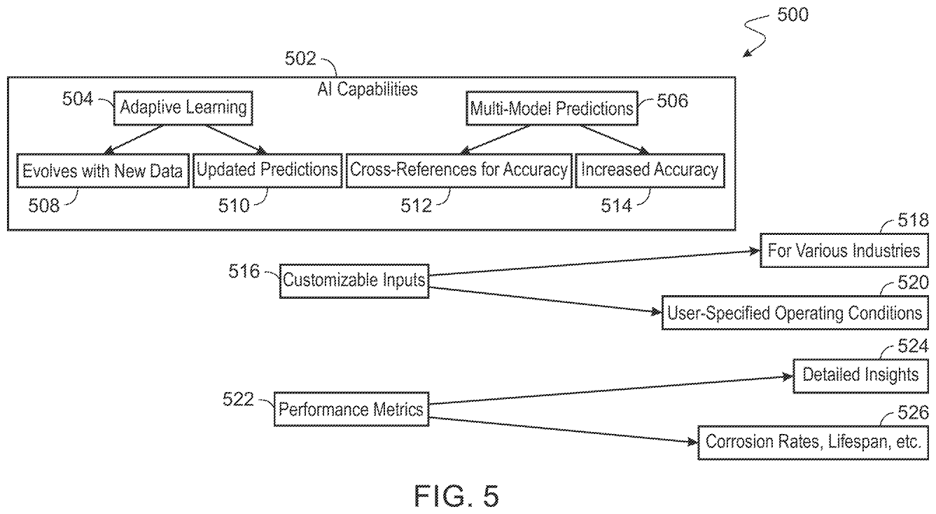

FIG. 5 shows capabilities of the integrated machine learning models 500. AI capabilities 502 are shown, including adaptive learning 504 and multi-model predictions 506. In adaptive learning, the machine learning models continually learn (508) and improve respective predictions (510) as more data becomes available. By utilizing multiple machine learning models (506), the system can cross-reference predictions (512) to increase accuracy (514).

Additionally, the inputs are customized {516) based on available data. The inputs can be customized for various industries (518). Users can input a wide range of operating conditions (520), making the system versatile for various industries.

The machine learning models can output performance metrics (522) on expected corrosion rates, lifespan, and other performance indicators (526). The machine learning models can also output detailed insights (524).

By leveraging AI and machine learning, the present systems and techniques offer more precise and accurate predictions on material performance compared to traditional manual assessments. The present systems and techniques continually learn and refine predictions as more data becomes available, ensuring that its recommendations are always up to date with the latest information. By predicting the best materials for specific conditions, the present systems and techniques can lead to significant cost savings in the long run. By reducing the need for frequent replacements and maintenance, organizations can save on material costs and labor. The AI-driven approach ensures that materials selected have a longer lifespan, leading to more durable structures, pipelines, and equipment. By selecting the most suitable materials, the overall performance of structures, pipelines, and equipment is optimized, leading to increased operational efficiency. Engineers and decision-makers no longer need to spend extensive time researching and testing materials. The AI-based system provides instant recommendations, speeding up the decision-making process. The invention promotes a data-driven approach to material selection, ensuring that decisions are based on empirical evidence rather than intuition or guesswork. The system is versatile and can be applied across various industries and applications, making it a universal solution for material selection challenges. By automating the material selection process, the chances of human error, which can lead to suboptimal choices, are significantly reduced. By ensuring the longevity of materials and reducing the frequency of replacements, there's a potential reduction in waste, promoting sustainability. Compared to existing methods that might rely on manual research, trial and error, or outdated databases, this invention offers a modern, efficient, and data-driven approach to material selection, ensuring optimal outcomes in both performance and cost-efficiency.

Referring again to FIG. 5, the various industries (518) include, for example, the oil and gas industry, where materials are selected for pipelines that transport crude oil, natural gas, and refined products. By choosing corrosion-resistant materials, companies can prevent leaks, enhance safety, and extend the lifespan of their infrastructure. The various industries (518) include, for example, civil engineering and construction industries, where materials are selected in the construction of bridges, buildings, and other structures. The machine learning models can recommend materials that are best suited for specific environmental conditions, ensuring durability and safety.

The various industries (518) include, for example, the aerospace and aviation industries, where materials are selected in aircraft construction. The machine learning models can recommend materials that can withstand high altitudes, temperature fluctuations, and pressure changes, optimizing aircraft performance and safety.

The various industries (518) include, for example, the automotive industry, where, where materials are selected in or vehicle parts, ensuring longevity, performance, and resistance to environmental factors.

The various industries (518) include, for example, the marine industry, where, where materials are selected for shipbuilding and offshore platforms. The machine learning models recommend materials that resist saltwater corrosion, enhancing the lifespan of marine structures.

The various industries (518) include, for example, the water treatment industry, where materials are selected or pipes and tanks that come into contact with various chemicals, ensuring the safety and purity of water.

The various industries (518) include, for example, the chemical industry, where, where materials are selected for reactors, storage tanks, and transportation systems that are resistant to chemical reactions.

The various industries (518) include, for example, the renewable energy industry, where, where materials are selected for wind turbines, solar panels, and other renewable energy infrastructure to withstand environmental conditions, ensuring efficient energy production.

The various industries (518) include, for example, the medical devices industry, where, where materials are selected that are that are biocompatible and resistant to sterilization processes.

The various industries (518) include, for example, the consumer electronics industry, where, where materials are selected that offer durability, heat resistance, and other desired properties, enhancing product lifespan.

The various industries (518) include, for example, the agriculture, where, where materials are selected for irrigation systems, greenhouses, and farming equipment to ensure longevity and resistance to various chemicals and environmental conditions.

Moreover, the present systems and techniques can be implemented in practical applications across the various industries. For example, companies can license the software for in-house use, integrating it into their design and manufacturing processes. Firms specializing in material science and engineering can use the system to offer consultation services to industries, providing expert material selection advice. The present systems and techniques can be integrated with Computer-Aided Design (CAD) software, allowing engineers and designers to receive material recommendations in real-time as they design. Moreover, educational institutions can use the present systems and techniques as a teaching tool for students studying material science, engineering, and related fields.

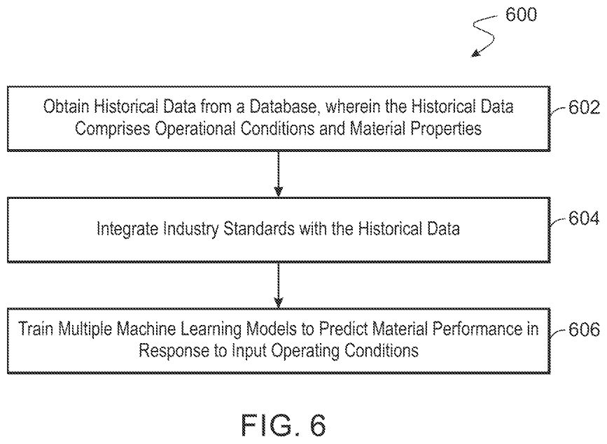

FIG. 6 is a process flow diagram 600 that enables the selection of materials for industrial assets using integrated machine learning models.

At block 602, historical data is obtained from a database, wherein the historical data comprises operational conditions and material properties.

At block 604, industry standards are integrated with the historical data, wherein the historical data is filtered to obtain multiple training datasets that comply with industry standards.

At block 606, multiple machine learning models are trained to predict material performance using the multiple training datasets, wherein predictions from the trained multiple machine learning models are cross-referenced to predict material performance in response to input operating conditions. In some embodiments, the long-term performance of materials under specific operating conditions is predicted using trained machine learning models. In examples, the multiple machine learning models are based on supervised learning techniques, including but not limited to Support Vector Machines or Decision Trees. The trained machine learning models are be updated, refined, and expanded to accommodate new materials and data.

In some embodiments, the predicted material performance is material degradation or failure that is predicted prior to occurrence using the trained machine learning models. In some embodiments, detailed explanations or interpretations are provided alongside AI-driven material recommendations to aid user understanding. Additionally, in some embodiments, safety protocols are used to evaluate the recommendations to alert users in case of highly uncertain or potentially unsafe material recommendations. Moreover, in some embodiments the real-world performance of recommended materials is simulated under specific operating conditions using the AI models.

The present systems and techniques improve the durability and safety of pipelines with materials selected as described herein, reducing the risk of leaks and ensuring uninterrupted energy supply. By selecting the most optimal materials for equipment and infrastructure, maintenance downtime is reduced, leading to increased operational efficiency and profitability. Further, by ensuring that materials have a longer lifespan and require fewer replacements, waste is reduced. As the selected materials are used in operations meet the highest safety standards, potential hazards are reduced. Selecting the most appropriate materials also leads to significant cost savings, both in terms of reduced maintenance and extended asset lifespan. Integrating data with machine learning models to refine predictions results in a more accurate model that is tailored to specific needs.

Further the present techniques reduce the risk of pipeline leaks, equipment failures, and other corrosion-related issues. For example, different materials have varying resistance to corrosion based on operating conditions. The present systems and techniques predict which materials will be most resistant to corrosion under specific conditions, reducing the risk of pipeline leaks, equipment failures, and other corrosion-related issues. Traditional methods of material selection rely on manual assessments or outdated databases. The present systems and techniques provide real-time, data-backed predictions on how materials will perform over time, ensuring optimal performance and longevity. By predicting the best materials for specific conditions, the present systems and techniques can reduce the frequency of maintenance and replacements, leading to smoother operations and reduced downtimes.

Further, the present systems and techniques are cost effective. Incorrect material selection can lead to frequent replacements, repairs, and potential operational hazards. By optimizing material selection, the present systems and techniques can lead to significant cost savings in both maintenance and potential risk mitigation. The present systems and techniques enable data-driven decision making and ensures that material selection decisions are backed by comprehensive data analysis, reducing uncertainties.

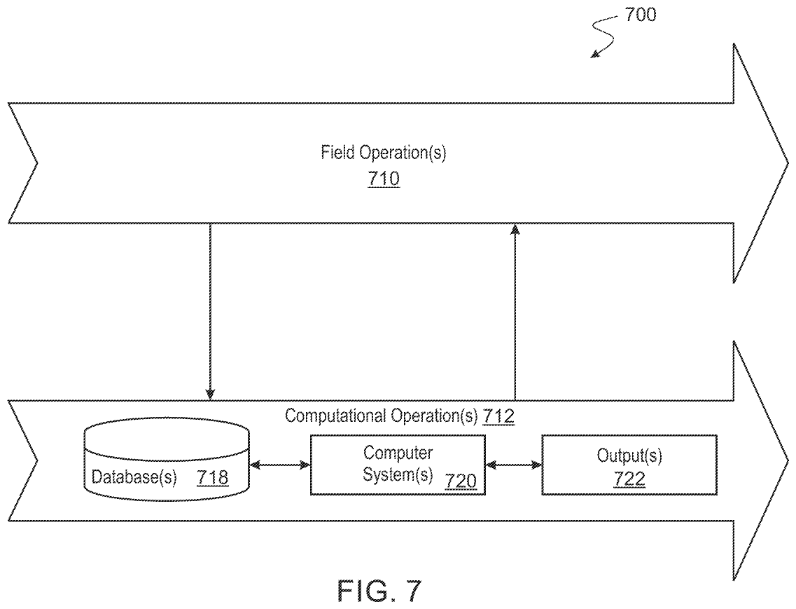

FIG. 7 illustrates hydrocarbon production operations 700 that include both one or more field operations 710 and one or more computational operations 712, which exchange information and control exploration for the production of hydrocarbons. In some implementations, outputs of techniques of the present disclosure can be performed before, during, or in combination with the hydrocarbon production operations 700, specifically, for example, either as field operations 710 or computational operations 712, or both.

Examples of field operations 710 include forming/drilling a wellbore, hydraulic fracturing, producing through the wellbore, injecting fluids (such as water) through the wellbore, to name a few. In some implementations, methods of the present disclosure can trigger or control the field operations 710. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 710 and responsively triggering the field operations 710 including, for example, generating plans and signals that provide feedback to and control physical components of the field operations 710. Alternatively or in addition, the field operations 710 can trigger the methods of the present disclosure. For example, implementing physical components (including, for example, hardware, such as sensors) deployed in the field operations 710 can generate plans and signals that can be provided as input or feedback (or both) to the methods of the present disclosure.

Examples of computational operations 712 include one or more computer systems 720 that include one or more processors and computer-readable media (e.g., non-transitory computer-readable media) operatively coupled to the one or more processors to execute computer operations to perform the methods of the present disclosure. The computational operations 712 can be implemented using one or more databases 718, which store data received from the field operations 710 and/or generated internally within the computational operations 712 (e.g., by implementing the methods of the present disclosure) or both. For example, the one or more computer systems 720 process inputs from the field operations 710 to assess conditions in the physical world, the outputs of which are stored in the databases 718. For example, seismic sensors of the field operations 710 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 712 where they are stored in the databases 718 and analyzed by the one or more computer systems 720.

In some implementations, one or more outputs 722 generated by the one or more computer systems 720 can be provided as feedback/input to the field operations 710 (either as direct input or stored in the databases 718). The field operations 710 can use the feedback/input to control physical components used to perform the field operations 710 in the real world.

For example, the computational operations 712 can process the seismic data to generate three-dimensional (3D) maps of the subsurface formation. The computational operations 712 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 712 to process new information about the formation and control the drilling to adjust to the observed conditions in real-time.

The one or more computer systems 720 can update the 3D maps of the subsurface formation as information from one exploration well is received and the computational operations 712 can adjust the location of the next exploration well based on the updated 3D maps. Similarly, the data received from production operations can be used by the computational operations 712 to control components of the production operations. For example, production well and pipeline data can be analyzed to predict slugging in pipelines leading to a refinery and the computational operations 712 can control machine operated valves upstream of the refinery to reduce the likelihood of plant disruptions that run the risk of taking the plant offline.

In some implementations of the computational operations 712, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

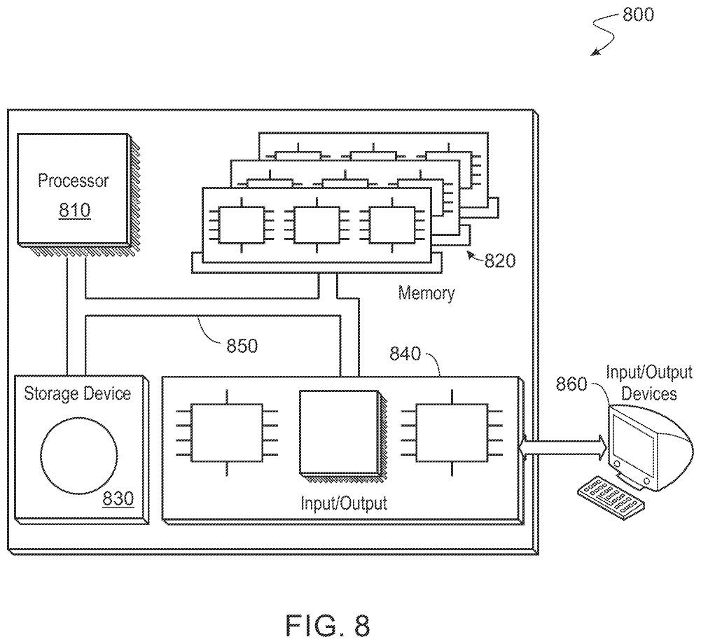

FIG. 8 is a schematic illustration of an example controller 800 (or control system) for that enables the selection of materials for industrial assets using integrated machine learning models. For example, the controller 800 may be operable according to the workflow 100 of FIG. 1, the process 400 of FIG. 4, or the process 600 of FIG. 6. In examples, the controller 800 may execute the implementation 300 of algorithms in FIG. 3. In some embodiments, the controller 800 includes the system 200 of FIG. 2. The controller 800 is intended to include various forms of digital computers, such as printed circuit boards (PCB), processors, digital circuitry, or otherwise parts of a system for the selection of materials for industrial assets using integrated machine learning models. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 800 includes a processor 810, a memory 820, a storage device 830, and an input/output interface 840 communicatively coupled with input/output devices 860 (for example, displays, keyboards, measurement devices, sensors, valves, pumps). Each of the components 810, 820, 830, and 840 are interconnected using a system bus 850. The processor 810 is capable of processing instructions for execution within the controller 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output interface 840.

The memory 820 stores information within the controller 800. In one implementation, the memory 820 is a computer-readable medium. In one implementation, the memory 820 is a volatile memory unit. In another implementation, the memory 820 is a nonvolatile memory unit.

The storage device 830 is capable of providing mass storage for the controller 800. In one implementation, the storage device 830 is a computer-readable medium. In various different implementations, the storage device 830 may be a floppy disk device, a hard disk device, an optical disk device, or a tape device.

The input/output interface 840 provides input/output operations for the controller 800. In one implementation, the input/output devices 860 includes a keyboard and/or pointing device. In another implementation, the input/output devices 860 includes a display unit for displaying graphical user interfaces.

There can be any number of controllers 800 associated with, or external to, a computer system containing controller 800, with each controller 800 communicating over a network. Further, the terms “client,” “user,” and other appropriate terminology can be used interchangeably, as appropriate, without departing from the scope of the present disclosure. Moreover, the present disclosure contemplates that many users can use one controller 800 and one user can use multiple controllers 800.

### EMBODIMENTS

According to some non-limiting embodiments or examples, provided is a computer-implemented method, including: obtaining, using at least one hardware processor, historical data from a database, wherein the historical data includes operational conditions, material properties, and performance metrics; integrating, using the at least one hardware processor, industry standards with the historical data, wherein the historical data is filtered to obtain multiple training datasets that comply with industry standards; and training, using the at least one hardware processor, one or more machine learning models to predict material performance using the multiple training datasets, wherein predictions from the trained one or more machine learning models are cross-referenced to predict material performance in response to input operating conditions.

According to some non-limiting embodiments or examples, provided is an apparatus including a non-transitory, computer readable, storage medium that stores instructions that, when executed by at least one processor, cause the at least one processor to perform operations including: obtaining historical data from a database, wherein the historical data includes operational conditions, material properties, and performance metrics; integrating industry standards with the historical data, wherein the historical data is filtered to obtain multiple training datasets that comply with industry standards; and training one or more machine learning models to predict material performance using the multiple training datasets, wherein predictions from the trained one or more machine learning models are cross-referenced to predict material performance in response to input operating conditions.

According to some non-limiting embodiments or examples, provided is a system, including: one or more memory modules; one or more hardware processors communicably coupled to the one or more memory modules, the one or more hardware processors configured to execute instructions stored on the one or more memory models to perform operations including: obtaining historical data from a database, wherein the historical data includes operational conditions, material properties, and performance metrics; integrating industry standards with the historical data, wherein the historical data is filtered to obtain multiple training datasets that comply with industry standards; and training one or more machine learning models to predict material performance using the multiple training datasets, wherein predictions from the trained one or more machine learning models are cross-referenced to predict material performance in response to input operating conditions.

Further non-limiting aspects or embodiments are set forth in the following numbered embodiments:

Embodiment 1: A computer-implemented method, including: obtaining, using at least one hardware processor, historical data from a database, wherein the historical data includes operational conditions, material properties, and performance metrics; integrating, using the at least one hardware processor, industry standards with the historical data, wherein the historical data is filtered to obtain multiple training datasets that comply with industry standards; and training, using the at least one hardware processor, one or more machine learning models to predict material performance using the multiple training datasets, wherein predictions from the trained one or more machine learning models are cross-referenced to predict material performance in response to input operating conditions.

Embodiment 2: The computer implemented method of any preceding embodiments, including integrating selection criteria with the historical data and industry standards, wherein the historical data is filtered to obtain multiple training datasets that comply with industry standards and satisfy selection criteria.

Embodiment 3: The computer implemented method of any preceding embodiments, including generating a recommendation for at least one material based on the predictions from the trained one or more machine learning models using a validation mechanism.

Embodiment 4: The computer implemented method of any preceding embodiments, including updating the trained one or more machine learning models using feedback data generated by the machine learning models.

Embodiment 5: The computer implemented method of any preceding embodiments, wherein an industry standard is predicted in response to the predicted material performance conflicting with industry standards.

Embodiment 6: The computer implemented method of any preceding embodiments, including weighting features in the training dataset that are more significant that other features.

Embodiment 7: The computer implemented method of any preceding embodiments, including cleaning and preprocessing the historical data to obtain the multiple training datasets.

Embodiment 8: An apparatus including a non-transitory, computer readable, storage medium that stores instructions that, when executed by at least one processor, cause the at least one processor to perform operations including: obtaining historical data from a database, wherein the historical data includes operational conditions, material properties, and performance metrics; integrating industry standards with the historical data, wherein the historical data is filtered to obtain multiple training datasets that comply with industry standards; and training one or more machine learning models to predict material performance using the multiple training datasets, wherein predictions from the trained one or more machine learning models are cross-referenced to predict material performance in response to input operating conditions.

Embodiment 9: The apparatus of any preceding embodiments, wherein the operations include integrating selection criteria with the historical data and industry standards, wherein the historical data is filtered to obtain multiple training datasets that comply with industry standards and satisfy selection criteria.

Embodiment 10: The apparatus of any preceding embodiments, wherein the operations include generating a recommendation for at least one material based on the predictions from the trained one or more machine learning models using a validation mechanism.

Embodiment 11: The apparatus of any preceding embodiments, wherein the operations include updating the trained one or more machine learning models using feedback data generated by the machine learning models.

Embodiment 12: The apparatus of any preceding embodiments, wherein an industry standard is predicted in response to the predicted material performance conflicting with industry standards.

Embodiment 13: The apparatus of any preceding embodiments, wherein the operations include weighting features in the training dataset that are more significant that other features.

Embodiment 14: The apparatus of any preceding embodiments, including cleaning and preprocessing the historical data to obtain the multiple training datasets.

Embodiment 15: A system, including: one or more memory modules; one or more hardware processors communicably coupled to the one or more memory modules, the one or more hardware processors configured to execute instructions stored on the one or more memory models to perform operations including: obtaining historical data from a database, wherein the historical data includes operational conditions, material properties, and performance metrics; integrating industry standards with the historical data, wherein the historical data is filtered to obtain multiple training datasets that comply with industry standards; and training one or more machine learning models to predict material performance using the multiple training datasets, wherein predictions from the trained one or more machine learning models are cross-referenced to predict material performance in response to input operating conditions.

Embodiment 16: The system of any preceding embodiments, wherein the operations include integrating selection criteria with the historical data and industry standards, wherein the historical data is filtered to obtain multiple training datasets that comply with industry standards and satisfy selection criteria.

Embodiment 17: The system of any preceding embodiments, wherein the operations include generating a recommendation for at least one material based on the predictions from the trained one or more machine learning models using a validation mechanism.

Embodiment 18: The system of any preceding embodiments, wherein the operations include updating the trained one or more machine learning models using feedback data generated by the machine learning models.

Embodiment 19: The system of any preceding embodiments, wherein an industry standard is predicted in response to the predicted material performance conflicting with industry standards.

Embodiment 20: The system of any preceding embodiments, wherein the operations include weighting features in the training dataset that are more significant that other features.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method, comprising:
obtaining, using at least one hardware processor, historical data from a database, wherein the historical data comprises operational conditions, material properties, and performance metrics;
integrating, using the at least one hardware processor, industry standards with the historical data, wherein the historical data is filtered to obtain multiple training datasets that comply with industry standards; and
training, using the at least one hardware processor, one or more machine learning models to predict material performance using the multiple training datasets, wherein predictions from the trained one or more machine learning models are cross-referenced to predict material performance in response to input operating conditions.

2. The computer implemented method of claim 1, comprising integrating selection criteria with the historical data and industry standards, wherein the historical data is filtered to obtain multiple training datasets that comply with industry standards and satisfy selection criteria.

3. The computer implemented method of claim 1, comprising generating a recommendation for at least one material based on the predictions from the trained one or more machine learning models using a validation mechanism.

4. The computer implemented method of claim 1, comprising updating the trained one or more machine learning models using feedback data generated by the machine learning models.

5. The computer implemented method of claim 1, wherein an industry standard is predicted in response to the predicted material performance conflicting with industry standards.

6. The computer implemented method of claim 1, comprising weighting features in the training dataset that are more significant that other features.

7. The computer implemented method of claim 1, comprising cleaning and preprocessing the historical data to obtain the multiple training datasets.

8. An apparatus comprising a non-transitory, computer readable, storage medium that stores instructions that, when executed by at least one processor, cause the at least one processor to perform operations comprising:
obtaining historical data from a database, wherein the historical data comprises operational conditions, material properties, and performance metrics;
integrating industry standards with the historical data, wherein the historical data is filtered to obtain multiple training datasets that comply with industry standards; and
training one or more machine learning models to predict material performance using the multiple training datasets, wherein predictions from the trained one or more machine learning models are cross-referenced to predict material performance in response to input operating conditions.

9. The apparatus of claim 8, wherein the operations comprise integrating selection criteria with the historical data and industry standards, wherein the historical data is filtered to obtain multiple training datasets that comply with industry standards and satisfy selection criteria.

10. The apparatus of claim 8, wherein the operations comprise generating a recommendation for at least one material based on the predictions from the trained one or more machine learning models using a validation mechanism.

11. The apparatus of claim 8, wherein the operations comprise updating the trained one or more machine learning models using feedback data generated by the machine learning models.

12. The apparatus of claim 8, wherein an industry standard is predicted in response to the predicted material performance conflicting with industry standards.

13. The apparatus of claim 8, wherein the operations comprise weighting features in the training dataset that are more significant that other features.

14. The apparatus of claim 8, comprising cleaning and preprocessing the historical data to obtain the multiple training datasets.

15. A system, comprising:
one or more memory modules;
one or more hardware processors communicably coupled to the one or more memory modules, the one or more hardware processors configured to execute instructions stored on the one or more memory models to perform operations comprising:
obtaining historical data from a database, wherein the historical data comprises operational conditions, material properties, and performance metrics;
integrating industry standards with the historical data, wherein the historical data is filtered to obtain multiple training datasets that comply with industry standards; and
training one or more machine learning models to predict material performance using the multiple training datasets, wherein predictions from the trained one or more machine learning models are cross-referenced to predict material performance in response to input operating conditions.

16. The system of claim 15, wherein the operations comprise integrating selection criteria with the historical data and industry standards, wherein the historical data is filtered to obtain multiple training datasets that comply with industry standards and satisfy selection criteria.

17. The system of claim 15, wherein the operations comprise generating a recommendation for at least one material based on the predictions from the trained one or more machine learning models using a validation mechanism.

18. The system of claim 15, wherein the operations comprise updating the trained one or more machine learning models using feedback data generated by the machine learning models.

19. The system of claim 15, wherein an industry standard is predicted in response to the predicted material performance conflicting with industry standards.

20. The system of claim 15, wherein the operations comprise weighting features in the training dataset that are more significant that other features.
